(19) United States
(12) Patent Application Publication
(10) Pub. No.: US 2026/0339239 A1
(43) Pub. Date: Oct. 29, 2026

(54) FIXING MEMBER, FIXING DEVICE, AND IMAGE FORMING APPARATUS

(71) Applicant: FUJIFILM Business Innovation Corp., Tokyo (JP)

(72) Inventors: Kosaku YOSHIMURA, Kanagawa (JP); Takashi HASEGAWA, Kanagawa (JP); Hiroki OGURA, Kanagawa (JP); Shimpei TAKAGI, Kanagawa (JP); Tatsuki SANO, Kanagawa (JP); Toshiyuki MIYATA, Kanagawa (JP); Keitaro MORI, Kanagawa (JP); Yasushi FUJIWARA, Kanagawa (JP); Hitoshi KOMURO, Kanagawa (JP)

(73) Assignee: FUJIFILM Business Innovation Corp., Tokyo (JP)

(21) Appl. No.: 19/468,516

(22) Filed: Feb. 3, 2026

(30) Foreign Application Priority Data
Apr. 28, 2025 (JP) 2025-074934

(51) Int. Cl. G03G 15/20; C10M 107/50; C10M 127/04; C10M 149/22; C10M 155/02

(52) U.S. Cl. CPC G03G 15/2025; C10M 107/50; C10M 127/04; C10M 149/22; C10M 155/02; G03G 15/2064; C10M 2205/04; C10M 2217/046; C10M 2229/02; C10M 2229/0415; G03G 2215/2009

(57) ABSTRACT

A fixing member includes at least a fixing belt, a pressurizing roll, a sliding member, and a lubricating composition, in which the lubricating composition contains at least one selected from the group consisting of a silicone oil and a modified silicone oil, and non-fluorine-based particles, a content of the non-fluorine-based particles is 20% by mass or more and 60% by mass or less with respect to the total mass of the lubricating composition, and a volume particle diameter D84v of the non-fluorine-based particles is 0.1 μm or more and 9.0 μm or less.

### CROSS-REFERENCE TO RELATED APPLICATIONS

This application is based on and claims priority under 35 USC 119 from Japanese Patent Application No. 2025-074934 filed Apr. 28, 2025.

### BACKGROUND

### (i) Technical Field

The present invention relates to a fixing member, a fixing device, and an image forming apparatus.

### (ii) Related Art

As a sliding material of a fixing member provided in an electrophotographic image forming apparatus, a fluorine-based grease having excellent chemical stability at a high temperature and having favorable sliding characteristics has been proposed (for example, JP2021-36034A).

On the other hand, there is an increasing social concern for reducing environmental load and health effects due to bioaccumulation, and fluorine compounds including perfluoropolyether or fluororesin resin particles contained in fluorine-based greases are also under consideration for regulation by laws and regulations in various countries including Europe and the United States. As a related art that does not use a fluorine compound, a silicone grease is known (for example, JP2023-165389A).

### SUMMARY

However, conventional silicone greases have a problem in that chemical stability at a high temperature is insufficient or torque increases during sliding at a high speed.

Aspects of non-limiting embodiments of the present disclosure relate to a lubricating composition that enables sliding with low torque against high temperature and high-speed friction during fixing without using a fluorine compound, and a fixing member using the lubricating composition.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided a fixing member including at least:
a fixing belt;
a pressurizing roll;
a sliding member; and
a lubricating composition,
in which the lubricating composition contains at least one selected from the group consisting of a silicone oil and a modified silicone oil, and non-fluorine-based particles,
a content of the non-fluorine-based particles is 20% by mass or more and 60% by mass or less with respect to a total mass of the lubricating composition, and
a volume particle diameter D84v of the non-fluorine-based particles is 0.1 μm or more and 9.0 μm or less.

### BRIEF DESCRIPTION OF THE DRAWINGS

Exemplary embodiment(s) of the present invention will be described in detail based on the following figures, wherein:

FIG. 1 is a view schematically showing an example of the image forming apparatus according to the present exemplary embodiment; and

FIG. 2 is a view schematically showing an example of the fixing device according to the present exemplary embodiment.

### DETAILED DESCRIPTION

Hereinafter, exemplary embodiments of the present invention will be described. The following descriptions and examples merely illustrate the exemplary embodiments, and do not limit the scope of the invention.

Regarding the numerical ranges described in stages in the present specification, the upper limit value or lower limit value of a numerical range may be replaced with the upper limit value or lower limit value of another numerical range described in stages. In addition, in the present specification, the upper limit value or lower limit value of a numerical range may be replaced with values described in examples.

Each component may include a plurality of kinds of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

In a case where the exemplary embodiments are described with reference to the drawings, members having substantially the identical function are marked with the same reference numeral throughout all the drawings such that the members will not be redundantly described.

### Fixing Member

The fixing member according to the present exemplary embodiment includes at least a fixing belt, a pressurizing roll, a sliding member, and a lubricating composition, in which the lubricating composition contains at least one selected from the group consisting of a silicone oil and a modified silicone oil, and non-fluorine-based particles, a content of the non-fluorine-based particles is 20% by mass or more and 60% by mass or less with respect to the total mass of the lubricating composition, and a volume particle diameter D84v of the non-fluorine-based particles is 0.1 μm or more and 9.0 μm or less.

In the fixing member according to the present exemplary embodiment, since the lubricating composition contains non-fluorine-based particles, the content of the non-fluorine-based particles is 20% by mass or more and 60% by mass or less with respect to the total mass of the lubricating composition, and the volume particle diameter D84v of the non-fluorine-based particles is 0.1 μm or more and 9.0 μm or less, without using a fluorine compound, it is possible to perform sliding with low torque, particularly sliding with low torque against high temperature and high-speed friction during fixing.

### Lubricating Composition

The fixing member according to the present exemplary embodiment includes a lubricating composition, in which the lubricating composition contains at least one selected from the group consisting of a silicone oil and a modified silicone oil, and non-fluorine-based particles, a content of the non-fluorine-based particles is 20% by mass or more and 60% by mass or less with respect to the total mass of the lubricating composition, and a volume particle diameter D84v of the non-fluorine-based particles is 0.1 μm or more and 9.0 μm or less.

At least one selected from group consisting of Silicone Oil and Modified Silicone Oil

The above-described lubricating composition contains at least one selected from the group consisting of a silicone oil and a modified silicone oil.

Examples of the silicone oil and the modified silicone oil include dimethyl silicone oil, organic metal salt-added dimethyl silicone oil, hindered amine-added dimethyl silicone oil, organic metal salt- and hindered amine-added dimethyl silicone oil, methylphenyl silicone oil, amino-modified silicone oil, organic metal salt-added amino-modified silicone oil, hindered amine-added amino-modified silicone oil, carboxy-modified silicone oil, silanol-modified silicone oil, and sulfonic acid-modified silicone oil.

Among these, from the viewpoint of sliding with low torque, for example, it is preferable to contain a silicone oil, it is more preferable to contain dimethyl silicone oil or methylphenyl silicone oil, and it is particularly preferable to contain dimethyl silicone oil.

From the viewpoint of sliding with low torque, the total content of the silicone oil and the modified silicone oil described above is, for example, preferably 40% by mass or more and 80% by mass or less, more preferably 45% by mass or more and 80% by mass or less, and still more preferably 50% by mass or more and 75% by mass or less with respect to the total mass of the lubricating composition.

### Non-Fluorine-Based Particles

The above-described lubricating composition contains non-fluorine-based particles.

The non-fluorine-based particles may be non-fluorine-based inorganic particles or non-fluorine-based organic particles, but from the viewpoint of sliding with low torque, for example, non-fluorine-based organic particles are preferable.

Examples of a material for the non-fluorine-based particles include a melamine cyanurate adduct (also referred to as “melamine cyanurate”), a silicone resin, molybdenum disulfide, molybdenum dithiocarbamate, molybdenum dithiophosphate, boron nitride, graphite, silica, onion-like carbon, mica, talc, and a phthalocyanine compound.

Among these, as the non-fluorine-based particles, from the viewpoint of sliding with low torque, for example, silicone resin particles or particles of a melamine-cyanuric acid adduct are preferable, and particles of a melamine-cyanuric acid adduct are particularly preferable.

The volume particle diameter D84v of the above-described non-fluorine-based particles is 0.1 μm or more and 9.0 μm or less. In a case where the volume particle diameter D84v is 0.1 μm or more and 9.0 μm or less, the lubricating composition easily enters a sliding portion, and thus sliding with low torque can be maintained. From the viewpoint of sliding with low torque, the volume particle diameter D84v is, for example, preferably 0.5 μm or more and 8.5 μm or less, more preferably 0.8 μm or more and 5.0 μm or less, and particularly preferably 1.0 μm or more and 3.0 μm or less.

Various average particle diameters of the particles are measured using LS COULTER (manufactured by Beckman Coulter, Inc., particle size measuring device).

For the particle size range (channel) divided based on the measured particle size distribution, a cumulative volume distribution and a cumulative number distribution are plotted from small-sized particles. The particle size at which the cumulative percentage of particles is 16% is defined as a volume particle diameter D16v and a number-based particle size D16p. The particle size at which the cumulative percentage of particles is 50% is defined as a volume average particle diameter D50v and a cumulative number-average particle size D50p. The particle size at which the cumulative percentage of particles is 84% is defined as a volume particle diameter D84v and a number-based particle size D84p.

The above-described non-fluorine-based particles may be contained alone or in combination of two or more kinds thereof.

The content of the above-described non-fluorine-based particles is 20% by mass or more and 60% by mass or less with respect to the total mass of the lubricating composition; and from the viewpoint of sliding with low torque, the content thereof is, for example, preferably 20% by mass or more and 55% by mass or less, and more preferably 25% by mass or more and 50% by mass or less.

### Other Additives

The above-described lubricating composition may contain other additives in addition to the silicone oil, the modified silicone oil, and the non-fluorine-based particles.

Examples of the other additives include known additives in the related art, such as an antioxidant.

A method of manufacturing the above-described lubricating composition is not particularly limited, and the lubricating composition is manufactured by mixing at least one selected from the group consisting of the silicone oil and the modified silicone oil, and the non-fluorine-based particles by a known mixing method.

### Fixing Belt, Pressurizing Roll, and Sliding Member

The fixing belt, the pressurizing roll, and the sliding member are not particularly limited, and may have a known configuration.

In addition, shapes and materials of the fixing belt, the pressurizing roll, and the sliding member are not particularly limited, and known ones can be used.

An example of the fixing member according to the present disclosure includes a fixing belt, a pressing member, a sliding member, and a halogen heater (an example of a heating source) disposed in the vicinity of the pressing member.

The pressurizing roll is disposed by being pressed against the fixing belt, and a sandwiching region N (nip portion) is formed in a region where the pressurizing roll and the fixing belt are in contact with each other.

### Other Configuration Members

The fixing member according to the present disclosure may further include other configuration members in addition to the fixing belt, the pressurizing roll, the sliding member, and the lubricating composition.

Examples of the other configuration members include the above-described pressing member.

In addition, for example, it is preferable that the fixing member according to the present disclosure includes a pressurizing roll, a fixing belt that is disposed in contact with the pressurizing roll, a pressing member that is disposed on an inner peripheral surface of the fixing belt and presses a second rotating body toward the pressurizing roll from the inner peripheral surface of the fixing belt, a sliding member that is interposed between the inner peripheral surface of the fixing belt and the pressing member, and a lubricating composition that is interposed between the inner peripheral surface of the fixing belt and the sliding member.

In addition, the sliding member used in the present exemplary embodiment may be a heating source such as a halogen heater, and the lubricating composition can be interposed between the heating source and the fixing belt for use.

### Fixing Device and Image Forming Apparatus

The fixing device according to the present exemplary embodiment is a fixing device including the fixing member according to the present exemplary embodiment.

The image forming apparatus according to the present exemplary embodiment includes an image holder, a latent image forming device that forms a latent image on a surface of the image holder, a developing device that develops the latent image into a toner image using a developer, a transfer device that transfers the developed toner image onto a recording medium, and the fixing device according to the present exemplary embodiment, that fixes the toner image on the recording medium.

Hereinafter, an example of the image forming apparatus and the fixing device according to the present exemplary embodiment will be described with reference to the drawings.

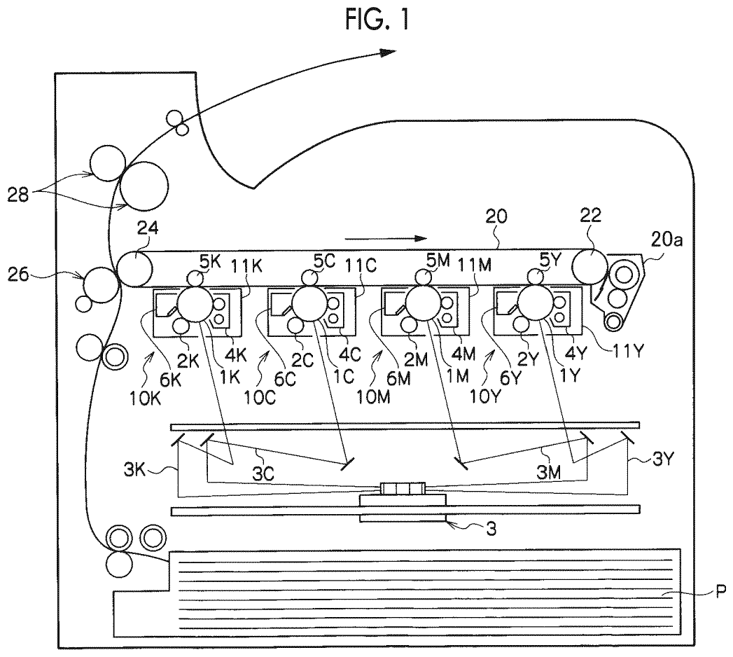

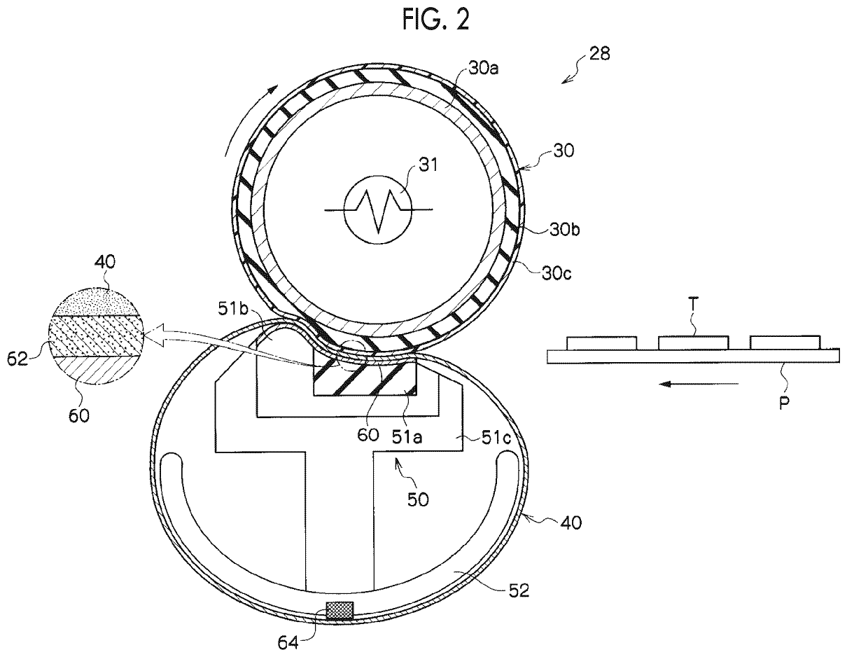

FIG. 1 is a view schematically showing an example of the image forming apparatus according to the present exemplary embodiment. FIG. 2 is a view schematically showing an example of the fixing device according to the present exemplary embodiment.

As shown in FIG. 1, an image forming apparatus 100 according to the present exemplary embodiment includes first to fourth process cartridges 10Y, 10M, 10C, and 10K (an example of image forming units) in an electrophotographic method that outputs an image of each of colors, yellow (Y), magenta (M), cyan (C), and black (K), based on color-separated image data. These process cartridges 10Y, 10M, 10C, and 10K are arranged to be separated from each other along an outer peripheral surface of an intermediate transfer belt 20. These process cartridges 10Y, 10M, 10C, and 10K are detachable from a body of the image forming apparatus.

The intermediate transfer belt 20 as an intermediate transfer body is provided above each of the process cartridges 10Y, 10M, 10C, and 10K (in FIG. 1) so that an outer peripheral surface thereof faces each process cartridge. The intermediate transfer belt 20 is wound around a drive roller 22 disposed apart from each other and a support roller 24 in contact with the inner peripheral surface of the intermediate transfer belt 20 to be disposed under application of a tension, and set to travel endlessly in a direction from the first process cartridge 10Y to the fourth process cartridge 10K.

The support roller 24 is pressed in a direction away from the drive roller 22 by an elastic member such as a spring (not shown), and a tension is applied to the intermediate transfer belt 20 wound between both the rollers. In addition, an intermediate transfer body cleaning device 20a facing the drive roller 22 is provided on the outer peripheral surface of the intermediate transfer belt 20.

Since the first to fourth process cartridges 10Y, 10M, 10C, and 10K have substantially identical configurations, the first process cartridge 10Y forming a yellow image, disposed on the upstream side in the traveling direction of the intermediate transfer belt, will be described herein as a representative. Identical reference numerals marked with magenta (M), cyan (C), and black (K) instead of yellow (Y) are assigned to portions that are identical to the reference numerals in the first process cartridge 10Y, such that the description on the second to fourth process cartridges 10M, 10C, and 10K will not be repeated.

The first process cartridge 10Y has a photoreceptor 1Y that acts as an image holder. Around the photoreceptor 1Y, a charging roller (an example of a charging device) 2Y that charges a surface of the photoreceptor 1Y to a predetermined potential, a development device 4Y that develops an electrostatic latent image by supplying a charged toner included in a developer to an electrostatic latent image, and a photoreceptor cleaning device 6Y that removes the toner remaining on a surface of the photoreceptor 1Y after the primary transfer are disposed in this order. These devices are integrally configured in a housing 11Y (casing). Similarly, in the second to fourth process cartridges 10M, 10C, and 10K, the respective members are integrally configured in housings 11M, 11C, and 11K (casing).

Together with the first process cartridge 10Y, a primary transfer roller 5Y (an example of a primary transfer device) that transfers the developed toner image onto the intermediate transfer belt 20, and an exposure device 3 that forms an electrostatic latent image by subjecting a charged surface to exposure with a laser beam 3Y based on a color-separated image signal are disposed to configure an image forming unit.

The charging roller 2Y and the exposure device 3 correspond to an example of the latent image forming device.

The primary transfer roller 5Y is disposed on the inner side of the intermediate transfer belt 20, at a position facing the photoreceptor 1Y. A bias power supply (not shown) that applies a primary transfer bias is connected to each of the primary transfer rollers 5Y, 5M, 5C, and 5K. Each bias power supply varies the transfer bias applied to each primary transfer roller under the control of a control unit (not shown).

As shown in FIG. 2, a fixing device 28 includes a heating roll 30 and a pressurizing belt 40, and the heating roll 30 and the pressurizing belt 40 are provided to face each other. The pressurizing belt 40 is pressed against the heating roll 30 by a pressing pad 50 (an example of a pressing member) disposed inside the inner peripheral portion thereof, and is guided along a belt traveling guide 52 under a pressure contact to form a contact portion and driven by receiving a driving force from the heating roll 30. In the drawing, T represents the toner image.

The heating roll 30 is configured, for example, by sequentially forming an elastic body layer 30b and a release layer 30c on a metal hollow metal core 30a having a heating source 31 such as a halogen lamp inside.

The metal core 30a is composed of, for example, a cylindrical metal body made of aluminum, stainless steel, or the like. The elastic body layer 30b is configured with, for example, HTV silicone rubber or fluororubber (JIS-A rubber hardness: approximately 45 degrees; a rubber hardness based on JIS K6301, as measured by a spring type of Durometer Type A manufactured by Teclock Co., Ltd. under a load of 1,000 gf added) with a thickness of approximately 2 mm or more and 5 mm or less. The release layer 30c is configured with, for example, fluororubber, silicone rubber, or a fluororesin with a thickness of 20 μm or more and 50 μm or less. Obviously, the release layer is not limited to the materials, and materials that are known in the related art may be used.

In the heating roll 30, a speed of the fixing roll is adjusted by a drive source (not shown), and the fixing roll is rotationally driven, for example, at a peripheral speed of 260 mm/sec. An outer diameter of the heating roll 30 is generally, for example, approximately 25 mm or more and 80 mm or less.

A surface temperature of the heating roll 30 is detected by a temperature sensor (not shown) coming into contact with the surface, and is controlled by a control circuit (not shown) such that the surface temperature is, for example, 175 °C.

The pressurizing belt 40 is configured by forming a release layer on a resin base material containing a heat-resistant resin such as a polyimide resin. The resin base material and the release layer are configured of a material known in the related art.

The pressing pad 50 has two pressing portions 51a and 51b having different hardnesses along a traveling direction of a recording medium P. The pressing portion 51a on the recording medium P entry side in the pressing pad 50 is configured with a rubber-like elastic member, the pressing portion 51b on the recording medium P discharge side is configured with a hard pressure applying member such as a metal, and a pressure in a contact region on the recording medium P discharge side is set to be higher than that on the recording medium P entry side. The pressing portions 51a and 51b are supported by a holder 51c and press the heating roll 30 from the inner peripheral surface of the pressurizing belt 40 through the sliding sheet 60 (an example of the sliding member).

A lubricating composition 62 is interposed between the sliding sheet 60 and the inner peripheral surface of the pressurizing belt 40. The lubricating composition 62 is supplied onto the inner peripheral surface of the pressurizing belt 40 by, for example, a lubricating composition supply member 64 provided in a part of the belt traveling guide 52, and interposed between the sliding sheet 60 and the inner peripheral surface of the pressurizing belt 40.

As the sliding sheet 60 (an example of the sliding member), for example, a sheet made of a heat-resistant resin may be applied. In addition, the sliding sheet 60 may contain other known additives in the related art.

Examples of the heat-resistant resin include a polyimide resin, a polyamide resin, a polyamide-imide resin, a polyetherimide resin, a polyethersulfone resin, a polyetherketone resin, a bismaleimide triazine resin, an aramid resin, a polyphenylene resin, and a polyphenylene sulfide resin.

Furthermore, the heat-resistant resin is a resin that melting or decomposition does not occur in a case of reaching a raised temperature of the device (for example, a fixing temperature).

The sliding sheet 60 may be porous (having a large number of fine pores). As a result, holding ability of the lubricating composition 62 is improved. Examples of the porous sliding sheet 60 include a porous sliding sheet obtained by foaming the heat-resistant resin, a porous sliding sheet obtained by stretching the heat-resistant resin in a uniaxial or biaxial direction, and a porous sliding sheet obtained by sintering molding.

In addition, in a case where the porous sliding sheet 60 is adopted, for example, a lubricating composition permeation prevention member (sheet member) that prevents permeation of the lubricating composition 62 to the pressing pad 50 side may be interposed between the sliding sheet 60 and the pressing pad 50.

A supply amount of the lubricating composition 62 need only be an amount that can cover the sliding sheet surface. This is because surplus is moved to a portion that does not cause a problem in function (a supply felt or a guide surface) as it is used.

Hereinafter, an image forming operation of the image forming apparatus according to the present exemplary embodiment will be described. An operation of forming a yellow image in the first process cartridge 10Y will be described as a representative of the image forming operation.

First, before the image forming operation, a surface of the photoreceptor 1Y is charged to, for example, a potential of approximately −600 V or more and −800 V or less by the charging roller 2Y.

The photoreceptor 1Y is formed by, for example, laminating a photosensitive layer on a conductive substrate. The photosensitive layer has properties in that the layer usually has a high resistance, but for example, in a case of being irradiated with the laser beam 3Y, a specific resistance of a portion irradiated with the laser beam changes. Therefore, through an exposure device 3, the laser beam 3Y is output to the surface of the charged photoreceptor 1Y according to the image data for yellow transmitted from the control unit (not shown). The photosensitive layer on the surface of the photoreceptor 1Y is irradiated with the laser beam 3Y such that an electrostatic latent image of a yellow printing pattern is formed on the surface of the photoreceptor 1Y.

In this manner, the electrostatic latent image formed on the photoreceptor 1Y is rotated to a development position as the photoreceptor 1Y travels. At the development position, the electrostatic latent image on the photoreceptor 1Y is developed to form a visible image (toner image) by the developing device 4Y.

For example, a developer containing a yellow toner and a carrier is accommodated in the developing device 4Y. The yellow toner is frictionally charged by being agitated inside in the developing device 4Y, and has the same polarity (negative polarity) as the charged electric charge on the photoreceptor 1Y. As the surface of the photoreceptor 1Y passes through the developing device 4Y, the yellow toner electrostatically adheres to only the neutralized latent image portion on the surface of the photoreceptor 1Y, and the latent image is developed by the yellow toner. The photoreceptor 1Y on which the yellow toner image is formed continues to travel, and the developed toner image on the photoreceptor 1Y is transported to a primary transfer position.

In a case where the yellow toner image on the photoreceptor 1Y is transported to the primary transfer position, a primary transfer bias is applied to the primary transfer roller 5Y, an electrostatic force from the photoreceptor 1Y toward the primary transfer roller 5Y acts on the toner image, and the toner image on the photoreceptor 1Y is transferred to the intermediate transfer belt 20. The transfer bias applied at this time has a polarity (+) opposite to the polarity (−) of the toner, and for example, in the first process cartridge 10Y, the transfer bias is subjected to a constant current control to approximately +10 μA by the control unit (not shown).

In addition, the primary transfer biases applied to the primary transfer rollers 5M, 5C, and 5K after the second process cartridge 10M are also controlled in the same manner.

In this way, the intermediate transfer belt 20 to which the yellow toner image is transferred by the first process cartridge 10Y is sequentially transported through the second to fourth process cartridges 10M, 10C, and 10K, and the toner images of the respective colors are superimposed and transferred in layers in the same manner.

The intermediate transfer belt 20 to which toner images of all colors are transferred in layers through the first to fourth process cartridges reaches a secondary transfer section configured with the intermediate transfer belt 20, the support roller 24 in contact with the inner peripheral surface of the intermediate transfer belt 20, and a secondary transfer roller (an example of a secondary transfer device) 26 disposed on the image holding surface side of the intermediate transfer belt 20. On the other hand, the recording medium P is fed to the gap between the secondary transfer roller 26 and the intermediate transfer belt 20 by a feeding mechanism, and secondary transfer bias is applied to the support roller 24. The transfer bias applied at this time has the same polarity (−) as the polarity (−) of the toner, and the electrostatic force heading for the recording medium P from the intermediate transfer belt 20 acts on the toner image, that makes the toner image on the intermediate transfer belt 20 transferred onto the recording medium P. The secondary transfer bias at this time is determined according to the resistance detected by a resistance detection section (not shown) that detects the resistance of the secondary transfer section, and is controlled at a constant voltage thereof.

The intermediate transfer belt 20, the primary transfer roller 5Y, and the secondary transfer roller 26 correspond to an example of the transfer device.

Thereafter, the recording medium P is sent to the fixing device 28, and inserted into a contact region formed by a pressure contact between the heating roll 30 rotationally driven in a direction of the arrow and the pressurizing belt 40. At this time, the recording medium P is inserted such that a surface of the recording medium P, on which an unfixed toner image has been formed, faces a surface of the heating roll 30. In a case where the recording medium P passes through the contact region, heat and pressure are applied to the recording medium P so that the unfixed toner image is fixed onto the recording medium P. The recording medium P after fixing passes through the contact region, is peeled off from the heating roll 30, and discharged from the fixing device 28.

In this manner, a fixing treatment is performed and the image is permanently fixed onto the recording medium P. The recording medium P on which the colored image has been fixed is transported to an output portion, and a series of colored image forming operations is finished.

### EXAMPLES

Examples will be described below, but the present invention is not limited to these examples. In the following description, unless otherwise specified, “part” and “%” are based on mass.

### Examples 1 to 11 and Comparative Examples 1 to 4

A silicone oil and a modified silicone oil shown in Table 1 are mixed with the amounts shown in Table 1, and non-fluorine-based particles shown in Table 1 are mixed with the amounts shown in Table 1 to obtain a lubricating composition.

The lubricating composition of each example is applied onto a sliding surface of a sliding sheet to obtain a sliding sheet with a lubricating composition.

The obtained sliding sheet with a lubricating composition is mounted on a sliding portion of a fixing device (including a fixing belt, a pressurizing roll, a sliding member, and the lubricating composition as a fixing member) of an image forming apparatus “Color1000 Press” manufactured by Fujifilm Business Innovation Corporation.

The obtained device is used as an evaluation machine to perform the following evaluation.

### Evaluation of Accumulation at Entrance of Sliding Portion

10,000 sheets of paper are passed through the above-described evaluation machine, and a white lubricating composition accumulated at the entrance of the sliding portion after the passing is observed, and a width of the accumulation is evaluated as follows.

A: width of accumulation is less than 1 mm.

B: width of accumulation is 1 mm or more and less than 3 mm.

C: width of accumulation is 3 mm or more.

### Torque Evaluation

A current value of rotation of the fixing member in the above-described evaluation machine is converted into a torque value, and a torque value in a case of passing 10,000 sheets of paper is evaluated.

The evaluation results are collectively shown in Table 1.

TABLE 1

| | Silicone oil and | | | | | | |
|---|---|---|---|---|---|---|---|
| | modified silicone oil | | Non-fluorine-based particles | | | Accumulation | |
| | | Content | | | Content | at entrance | |
| | | (% by | | D84v | (% by | of sliding | Torque |
| | Type | mass) | Type | (μm) | mass) | portion | (N · m) |
| Example 1 | Silicone | 60 | MCA | 2.2 | 40 | A | 0.88 |
| | oil A | | | | | | |
| Example 2 | Silicone | 60 | MCA | 2.2 | 40 | A | 0.76 |
| | oil B | | | | | | |
| Example 3 | Silicone | 60 | MCA | 2.2 | 40 | A | 0.92 |
| | oil C | | | | | | |
| Example 4 | Silicone | 60 | Silicone | 3.6 | 40 | B | 1.10 |
| | oil B | | powder A | | | | |
| Example 5 | Silicone | 60 | Silicone | 1.2 | 40 | A | 0.98 |
| | oil B | | powder B | | | | |
| Example 6 | Silicone | 60 | MCA | 3.1 | 40 | B | 0.96 |
| | oil B | | | | | | |
| Example 7 | Silicone | 60 | MCA | 8.2 | 40 | B | 1.14 |
| | oil B | | | | | | |
| Example 8 | Silicone | 75 | MCA | 2.2 | 25 | A | 0.88 |
| | oil B | | | | | | |
| Example 9 | Silicone | 50 | MCA | 2.2 | 50 | A | 0.99 |
| | oil B | | | | | | |
| Example 10 | Modified | 60 | MCA | 2.2 | 40 | A | 0.68 |
| | silicone | | | | | | |
| | oil D | | | | | | |
| Example 11 | Silicone | 60 | Crosslinked | 2.4 | 40 | B | 1.04 |
| | oil B | | polystyrene | | | | |
| | | | particles | | | | |
| Comparative | Silicone | 55 | MCA | 15.4 | 45 | C | >1.2 |
| Example 1 | oil B | | | | | | |
| Comparative | Silicone | 85 | MCA | 2.2 | 15 | A | >1.2 |
| Example 2 | oil B | | | | | | |
| Comparative | Silicone | 35 | MCA | 2.2 | 65 | B | >1.2 |
| Example 3 | oil B | | | | | | |
| Comparative | Silicone | 70 | Sodium 12- | — | 30 | C | >1.2 |
| Example 4 | oil B | | hydroxystearate | (mesh | | | |
| | | | | structure) | | | |

Details of materials or abbreviations used in the examples shown in Table 1 are as follows.

Silicone oil A: dimethyl silicone oil, KF-96A-100cs (manufactured by Shin-Etsu Chemical Co., Ltd.)

Silicone oil B: dimethyl silicone oil, KF-96A-300cs (manufactured by Shin-Etsu Chemical Co., Ltd.)

Silicone oil C: dimethyl silicone oil, KF-96A-1000cs (manufactured by Shin-Etsu Chemical Co., Ltd.)

Modified silicone oil D: diamine-modified silicone oil, KF-860 (manufactured by Shin-Etsu Chemical Co., Ltd.)

MCA: particles of a melamine-cyanuric acid adduct; MC-4000 (manufactured by Nissan Chemical Corporation) is used after classification or after crushing and classification Silicone powder A: KMP-590 (manufactured by Shin-Etsu Chemical Co., Ltd.) Silicone powder B: X-52-854 (manufactured by Shin-Etsu Chemical Co., Ltd.) Crosslinked polystyrene particles: manufactured by Sekisui Kasei Co., Ltd.

From the above results, the fixing member of Examples has, for example, more favorable permeability of the lubricating composition into the sliding portion than the fixing member of Comparative Examples, and can perform sliding with low torque without using a fluorine compound.

(((1))) A fixing member comprising at least:
a fixing belt;
a pressurizing roll;
a sliding member; and
a lubricating composition,
wherein the lubricating composition contains at least one selected from the group consisting of a silicone oil and a modified silicone oil, and non-fluorine-based particles,
a content of the non-fluorine-based particles is 20% by mass or more and 60% by mass or less with respect to a total mass of the lubricating composition, and
a volume particle diameter D84v of the non-fluorine-based particles is 0.1 μm or more and 9.0 μm or less.

(((2))) The fixing member according to (((1))),
wherein the non-fluorine-based particles are non-fluorine-based organic particles.

(((3))) The fixing member according to (((2))),
wherein the non-fluorine-based particles are particles of a melamine-cyanuric acid adduct.

(((4))) The fixing member according to any one of (((1))) to (((3))),
wherein the volume particle diameter D84v of the non-fluorine-based particles is 0.1 μm or more and 5.0 μm or less.

((5))) The fixing member according to (((4))),
wherein the volume particle diameter D84v of the non-fluorine-based particles is 0.1 μm or more and 3.0 μm or less.

(((6))) The fixing member according to any one of (((1))) to (5))
wherein the content of the non-fluorine-based particles is 25% by mass or more and 50% by mass or less with respect to the total mass of the lubricating composition.

(((7))) The fixing member according to any one of (((1))) to (((6))),
wherein a total content of the silicone oil and the modified silicone oil is 40% by mass or more and 80% by mass or less with respect to the total mass of the lubricating composition.

(((8))) A fixing device comprising:
the fixing member according to any one of (((1))) to (((7))).

(((9))) An image forming apparatus comprising:
an image holder;
a latent image forming device that forms a latent image on a surface of the image holder;
a developing device that develops the latent image into a toner image using a developer;
a transfer device that transfers the developed toner image onto a recording medium; and
the fixing device according to (((8))), that fixes the toner image on the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing member comprising at least:
a fixing belt;
a pressurizing roll;
a sliding member; and
a lubricating composition,
wherein the lubricating composition contains at least one selected from the group consisting of a silicone oil and a modified silicone oil, and non-fluorine-based particles,
a content of the non-fluorine-based particles is 20% by mass or more and 60% by mass or less with respect to a total mass of the lubricating composition, and
a volume particle diameter D84v of the non-fluorine-based particles is 0.1 μm or more and 9.0 μm or less.

2. The fixing member according to claim 1,
wherein the non-fluorine-based particles are non-fluorine-based organic particles.

3. The fixing member according to claim 2,
wherein the non-fluorine-based particles are particles of a melamine-cyanuric acid adduct.

4. The fixing member according to claim 1,
wherein the volume particle diameter D84v of the non-fluorine-based particles is 0.1 μm or more and 5.0 μm or less.

5. The fixing member according to claim 4,
wherein the volume particle diameter D84v of the non-fluorine-based particles is 0.1 μm or more and 3.0 μm or less.

6. The fixing member according to claim 1,
wherein the content of the non-fluorine-based particles is 25% by mass or more and 50% by mass or less with respect to the total mass of the lubricating composition.

7. The fixing member according to claim 1,
wherein a total content of the silicone oil and the modified silicone oil is 40% by mass or more and 80% by mass or less with respect to the total mass of the lubricating composition.

8. A fixing device comprising:
the fixing member according to claim 1.

9. A fixing device comprising:
the fixing member according to claim 2.

10. A fixing device comprising:
the fixing member according to claim 3.

11. A fixing device comprising:
the fixing member according to claim 4.

12. A fixing device comprising:
the fixing member according to claim 5.

13. A fixing device comprising:
the fixing member according to claim 6.

14. A fixing device comprising:
the fixing member according to claim 7.

15. An image forming apparatus comprising:
an image holder;
a latent image forming device that forms a latent image on a surface of the image holder;
a developing device that develops the latent image into a toner image using a developer;
a transfer device that transfers the developed toner image onto a recording medium; and
the fixing device according to claim 8, that fixes the toner image on the recording medium.

16. An image forming apparatus comprising:
an image holder;
a latent image forming device that forms a latent image on a surface of the image holder;
a developing device that develops the latent image into a toner image using a developer;
a transfer device that transfers the developed toner image onto a recording medium; and
the fixing device according to claim 9, that fixes the toner image on the recording medium.

17. An image forming apparatus comprising:
an image holder;
a latent image forming device that forms a latent image on a surface of the image holder;
a developing device that develops the latent image into a toner image using a developer;
a transfer device that transfers the developed toner image onto a recording medium; and
the fixing device according to claim 10, that fixes the toner image on the recording medium.

18. An image forming apparatus comprising:
an image holder;
a latent image forming device that forms a latent image on a surface of the image holder;
a developing device that develops the latent image into a toner image using a developer;
a transfer device that transfers the developed toner image onto a recording medium; and
the fixing device according to claim 11, that fixes the toner image on the recording medium.

19. An image forming apparatus comprising:
an image holder;
a latent image forming device that forms a latent image on a surface of the image holder;
a developing device that develops the latent image into a toner image using a developer;
a transfer device that transfers the developed toner image onto a recording medium; and
the fixing device according to claim 12, that fixes the toner image on the recording medium.

20. An image forming apparatus comprising:
an image holder;
a latent image forming device that forms a latent image on a surface of the image holder;
a developing device that develops the latent image into a toner image using a developer;
a transfer device that transfers the developed toner image onto a recording medium; and
the fixing device according to claim 13, that fixes the toner image on the recording medium.
